(19) United States
(12) Patent Application Publication
(10) Pub. No.: US 2018/0373676 A1
(43) Pub. Date: Dec. 27, 2018

(54) Apparatus and Methods of Providing an Efficient Radix-R Fast Fourier Transform

(71) Applicant: Jaber Technology Holdings US Inc., Wimberley, TX (US)

(72) Inventors: Marwan A. Jaber, Saint-Leonard (CA); Radwan A. Jaber, Saint-Leonard (CA)

(73) Assignee: Jaber Technology Holdings US Inc., Wimberley, TX (US)

(21) Appl. No.: 15/923,518

(22) Filed: Mar. 16, 2018

Related U.S. Application Data
(60) Provisional application No. 62/472,162, filed on Mar. 16, 2017.

(51) Int. Cl. G06F 17/14; G06F 7/498

(52) U.S. Cl. CPC G06F 17/142; G06F 7/72; G06F 7/4981

(57) ABSTRACT

In some embodiments, an apparatus can include a memory configured to store data at a plurality of addresses and a generalized radix-r fast Fourier transform (FFT) processor configured to determine a plurality of FFTs for any positive integer Discrete Fourier Transform (DFT) by utilizing three counters to access the data and the coefficient multipliers at each stage of the FFT processor.

### NOTICE OF COPYRIGHTS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The present disclosure is a non-provisional of and claims priority to U.S. Provisional Application No. 62/472,162 filed on Mar. 16, 2017 and entitled “Apparatus and Methods of Providing an Efficient Radix-R Fast Fourier Transform”, which is incorporated herein by reference in its entirety.

### FIELD

The present disclosure is generally related to the field of data processing, and more particularly to data processing apparatuses and methods of providing Fast Fourier transformations, such as devices, systems, and methods that perform real-time signal processing and off-line spectral analysis. In some aspects, the data processing system may implement an efficient, generalized radix-r fast Fourier Transformation (FFT) that allow the efficient calculation of discrete Fourier transformations of data of arbitrary size, including prime sizes, which may provide an improvement in processing efficiency and speed by reducing the overall number of memory accesses (which may be internal to the processor core) to complete the operation.

### BACKGROUND

A sampled data signal can be transformed from the time domain to a frequency domain using a Discrete Fourier Transform (DFT). Conversely a sampled data signal can be transformed from the frequency domain to a time domain using an Inverse DFT (IDFT). The DFT is a fundamental digital signal-processing transformation that provides spectral information (frequency content) for analysis of signals. The DFT allows for signal content to be analyzed in the frequency domain, which allows for efficient computation of the convolution integral that can be used in linear filtering and signal correlation analysis. However, since direct computation of the DFT uses a large number of arithmetic operations, it can be impractical for direct computation of DFTs in real-time applications.

In an example, the computational burden is a measure of a number of calculations to be determined. The DFT (and IDFT) process starts with a number (N) of input data points and computes a number (N) of output data points. The DFT is a function of a sum of products (repeated multiplication of two factors). The Fast Fourier Transform (FFT) reduced the computational burden, allowing the FFT to be used in diverse applications, such as digital filtering, audio processing, spectral analysis for speech recognition, and so on. In particular, the FFT utilizes a divide-and-conquer approach that divides the input data into subsets from which the DFT is computed.

The FFT algorithm can be memory access and storage intensive. For example, to calculate a radix-4 FFT butterfly, four pieces of data and three “twiddle” coefficients can be read from memory, and four pieces of resultant data are written back to memory. In an FFT implementation, an address generator can be used to compute the addresses (locations in memory) where input data, output data, and twiddle coefficients will be stored and retrieved from memory. The time required to read input data and twiddle coefficients from the memory and to write results back to memory affects the overall time to compute the FFT. The time required to calculate the address can also impact the overall time to compute the FFT.

### SUMMARY

In some embodiments, a system can be configured to utilize a generalized, Radix-r FFT, which implements a word counter and shifting counter in a decimation-in-time (DIT) process or in a decimation-in-frequency (DIF) process to achieve a self-sorting radix-r algorithm in which access to the coefficient multiplier's memory can be reduced as compared to conventional radix-r algorithms.

In certain embodiments, systems, methods and circuits are disclosed that can utilize a generalized FFT process with an FFT address generator that can compute the FFT of an input data having a size that is a multiple of an arbitrary integer without adding to the memory requirements. In an example of one possible advantage provided by the generalized FFT process with the FFT address generator described herein, the systems, methods, and circuits can reduce memory access relative to prior address generators by regrouping the data with its corresponding coefficient multiplier.

Embodiments of a generalized radix-r FFT, as disclosed herein, can be used in a wide range of signal processing and fast computational algorithms. The reduction in computational time provided by the generalized radix-r FFT finds applications in both real-time signal processing and off-line spectral analysis. Further, the generalized radix-r FFT can be used in a variety of applications, including speech, satellite and terrestrial communications; wired and wireless digital communications; multi-rate signal processing; target tracking and identifications; radar and sonar systems; machine monitoring; seismology; biomedicine; encryption; video processing; gaming; convolution neural networks; digital signal processing; image processing; speech recognition; computational analysis; autonomous cars; deep learning; and other applications.

In some embodiments, an apparatus can include a memory configured to store data at a plurality of addresses. The apparatus can further include a generalized radix-r fast Fourier transform (FFT) processor configured to determine a plurality of FFTs for any positive integer Discrete Fourier Transform (DFT) by utilizing three counters to access the data and the coefficient multipliers at each stage of the FFT processor.

In one possible aspect, the positive integer DFT can be a multiple of an integer. In another possible aspect, the positive integer DFT can be a prime number. In still another aspect, the generalized radix-r fast FFT processor can be configured to perform at least one of a Decimation in Frequency (DIF) operation and a Decimation in Time (DIT) operation. In still another aspect, the generalized radix-r fast FFT processor may include an address generator configured to reduce accesses to coefficient multipliers of the FFTs stored by the plurality of addresses of the memory by regrouping data with their corresponding coefficient multipliers.

In other embodiments, an apparatus may include an input configured to receive input data having a size that is a multiple of an arbitrary integer a. The apparatus may further include a memory configured to store data at a plurality of addresses and may include a generalized radix-R fast Fourier transform (FFT) processor coupled to the input into the memory. The generalized radix-r FFT processor may be configured to determine an FFT of the input data using three counters to access data and coefficient multipliers at each stage of the FFT processor.

In still other embodiments, an apparatus may include a memory configured to store data at a plurality of addresses. The apparatus may further include a generalized radix-r fast Fourier transform (FFT) processor configured to determine a plurality of FFTs for any positive integer Discrete Fourier Transform (DFT) by utilizing three counters to access the data and the coefficient multipliers at each stage of a plurality of stages of the FFT processor. The plurality of stages may include an FFT stage and at least one butterfly stage.

### BRIEF DESCRIPTION OF THE DRAWINGS

FIG. 1 depicts a block diagram of a data processing apparatus configured to implement a generalized, radix-r FFT

FIG. 2 depicts a block diagram of a FFT decomposition.

FIG. 3 depicts a system including three-stages in a computation of an N=8-point decimation-in-time (DIT) discrete Fourier transform (FFT).

FIG. 4 depicts a system including three-stages in an eight-point DIF FFT.

FIG. 5 depicts an eight-point DIF FFT signal flow graph.

FIG. 6 illustrates a butterfly computation for the DIF FFT.

FIG. 7 depicts a general flow diagram of a DIT Radix-r address generator, in accordance with certain embodiments of the disclosure.

FIG. 8 depicts MATLAB® source code for a DIT FFT, in accordance with certain embodiments of the prior art disclosure of U.S. Pat. No. 6,993,547.

FIG. 9 depicts a block diagram of a logic circuit 900 configured to implement a modified radix-3 Butterfly operation, in accordance with certain embodiments of the disclosure.

FIG. 10 depicts a flow diagram of a method of implementing a DIT radix-r address generator, in accordance with certain embodiments of the present disclosure.

FIG. 11 depicts a flow diagram of a method of implementing a radix-r address generator with a butterfly computation, in accordance with certain embodiments of the present disclosure.

FIG. 12 depicts MATLAB® source code of a radix-r FFT with its address generator, in accordance with certain embodiments of the present disclosure.

FIG. 13 depicts MATLAB® source code for the butterfly Radix-r represented by the function called by the MATLAB® source code of FIG. 12.

FIG. 14 depicts MATLAB® source code of a radix-r FFT with a butterfly adder tree matrix and the coefficient multipliers incorporated into a single stage of computation, in accordance with certain embodiments of the present disclosure.

FIG. 15 depicts a block diagram of a radix-r DIT butterfly, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Despite many new technologies, the Fourier transform may remain the workhorse for signal processing analysis. The Fast Fourier Transform (FFT) is an algorithm that can be applied to compute the Discrete Fourier transform (DFT) and its inverse, both of which can be optimized to remove redundant calculations. These optimizations can be made when the number of samples to be transformed is an exact power of two and, if not, the number of samples can be zero padded to the nearest number that is power of two.

The present disclosure may be embodied in one or more address generators that can be used in conjunction with one or more butterfly processing elements. The one or more address generators can be configured to support a generalized radix-r FFT that may allow the efficient calculation of discrete Fourier transform of arbitrary sizes, including prime sizes. In some embodiments, the embodiments of the present disclosure may utilize a computing device including an interface coupled to a processor and configured to receive data. The processor may be configured to apply a butterfly computation, which may include a simple multiplication of input data with an appropriate coefficient multiplier. In the context of an FFT computation, a butterfly computation is a portion of the DFT computation that combines the results of smaller DFTs into a larger DFT (or vice versa) or segments a larger DFT into smaller DFTs. These smaller DFTs may be written to or read from memory, and such read/write operations contribute to the overall speed of the DFT computation. Embodiments of a system in accordance with the present disclosure may include one or more simple address generators (AGs), which can compute address sequences from a small parameter set that describes the address pattern.

A processor may be configured to implement a butterfly operation (or may be configured to compute the mathematical transformations), and dataflow may be controlled by an independent device or by another processor of the device. In an embodiment, peripheral devices may be used to control data transfers between an I/O (Input/Output) subsystem and a memory subsystem in the same manner that a processor can control such transfers, reduce core processor interrupt latencies, and conserve digital signal processor (DSP) cycles for other tasks leading to increased performance. Embodiments described herein may present a generalized radix-r FFT that allows the efficient calculation of DFTs of arbitrary size, and including prime sizes.

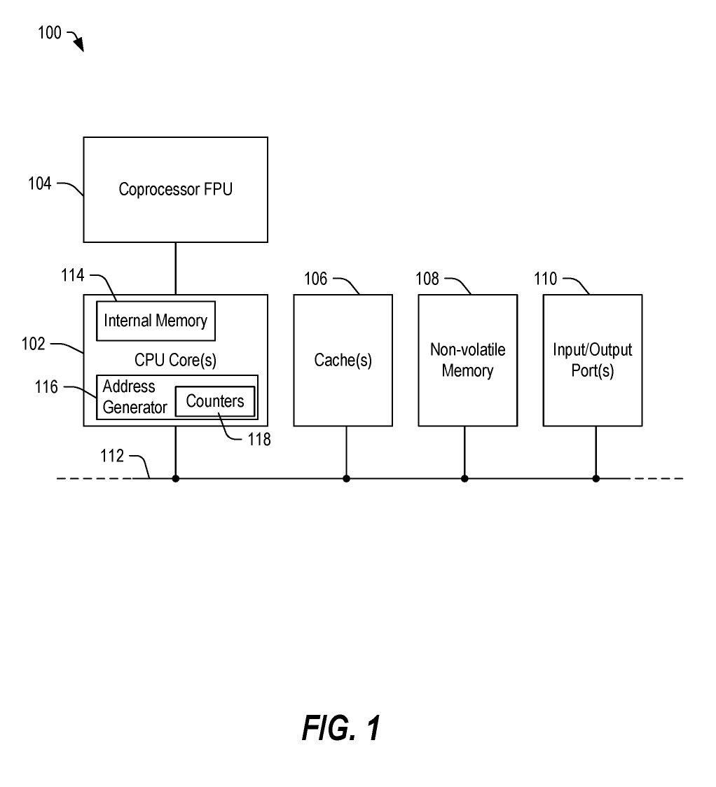

Referring now to FIG. 1, a block diagram of a data processing apparatus is generally indicated as 100 and that may be configured to implement a generalized, radix-r FFT, in accordance with certain embodiments of the present disclosure. The data processing apparatus 100 may include one or more central processing unit (CPU) cores 102, each of which may include one or more processing cores. In some embodiments, the one or more CPU cores 102 may be implemented as a single computing component with two or more independent processing units (or cores), each of which may be configured to read and write data and to execute instructions on the data. Each core of the one or more CPU cores 102 may be configured to read and execute central processing unit (CPU) instructions, such as add, move data, branch, and so on. Each core may operate in conjunction with other circuits, such as one or more cache memory devices 106, memory management, registers, non-volatile memory 108, and input/output ports 110.

In some embodiments, the one or more CPU cores 102 can include internal memory 114, such as registers and memory management. Further, the one or more CPU cores 102 can include an address generator 116 including a plurality of counters 118. In some embodiments, the one or more CPU cores 102 can be coupled to a floating-point unit (FPU) processor 104.

The one or more CPU cores 102 can be configured to process data using FFT DIF operations or FFT DIT operations. Embodiments of the present disclosure utilize an address generator 116 including a plurality of counters 118 to provide generalized radix-r FFTs, which allow for the efficient calculation of discrete Fourier transforms of arbitrary sizes, including prime sizes. The address generator 116 and the counters 118 can be used to reduce the overall number of memory accesses (read operations and write operations) for the various FFT calculations, thereby enhancing the overall efficiency, speed and performance of the one or more CPU cores 102.

It should be appreciated that the FFT operations may be managed using a dedicated processor or processing circuit. In some embodiments, the FFT operations may be implemented as CPU instructions that can be executed by the individual processing cores of the one or more CPU cores 102 in order to manage memory accesses and various FFT computations.

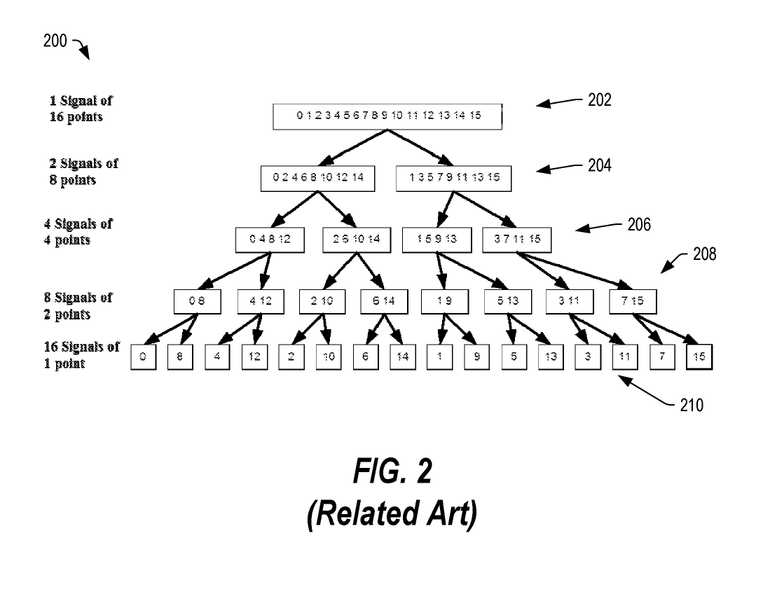

In order to appreciate the improvements to the processing cores provided by the present disclosure, it is important to understand at least one possible implementation of the FFT computations. In the following discussion of FIGS. 2-6 and 8, one possible implementation of an FFT computation is disclosed, which may be used in conjunction with the address generator 116 and counters 118 to improve the overall efficiency and processing speed of an apparatus, enabling real-time signal processing of complex data sets as well as efficient off-line spectral analysis, because the overall number of memory accesses (which can introduce delays) are reduced. Further, the radix-r FFT can be used in a variety of data processing systems, including speech, satellite and terrestrial communications; wired and wireless digital communications; multi-rate signal processing; target tracking and identifications; radar and sonar systems; machine monitoring; seismology; biomedicine; encryption; video processing; gaming; convolution neural networks; digital signal processing; image processing; speech recognition; computational analysis; autonomous cars; deep learning; and other applications. Other embodiments are also possible.

FIG. 2 depicts a block diagram of an FFT decomposition, generally indicated at 200. The FFT decomposition 200 depicts an N-point signal decomposed into N-signals, each including a single point. The FFT decomposition 200 includes a plurality of stages including an initial stage 202 including a single signal of sixteen points. Each stage of the FFT decomposition 200 can utilize an interlace decomposition that can be used to separate even and odd samples. The signal of sixteen points can be decomposed from a single signal at the initial stage 202 into two signals of eight points each at a second stage 204. The two signals of eight points each are created using an interlace decomposition that separates the even and odd numbered samples. The two signals can be further decomposed into four signals using the interlace decomposition at a third stage 206.

Further, the four signals can be decomposed into eight signals using the interlace decomposition at a fourth stage 208. The eight signals can be decomposed into sixteen signals using the interlace decomposition at a fifth stage 210.

Each of the stages uses an array of a size that is a power of two. If the data size is not a power of two, it can be zero padded to the nearest number that is a power of two. As used herein, the term “zero padded” refers to the insertion of a plurality of zeros at the beginning or end of a number in order to fill the array to form an array having a size that is a power of two. All the above cited algorithms require data sizes that have been power of two and if not it should be zero padded to the nearest number that is power of two. Zero-padding from a natural computation size to the nearest two-to-a-power size introduces increased computational complexity and memory requirements and reduces accuracy, especially in multidimensional problems.

The definition of the DFT is represented by the following equation:

$${X}_{( k )} = {\sum }_{n = 0}^{N - 1} {x}_{( n )} {w}_{N}^{nk} , k ∈ [ 0 , N - 1 ] , \qquad ( 1 )$$

where x₍ₙ₎ represents the input sequence, X₍ₖ₎ represents the output sequence, N represents the transform length, and w_{N} represents the N^{th} root of unity, w_{N}=e^{-j2π/N}. Both the input sequence (x₍ₙ₎) and the output sequence (X₍ₖ₎) are complex valued sequences of length N=r^{S}, where the variable r represents the radix and the variable S represents the number of stages.

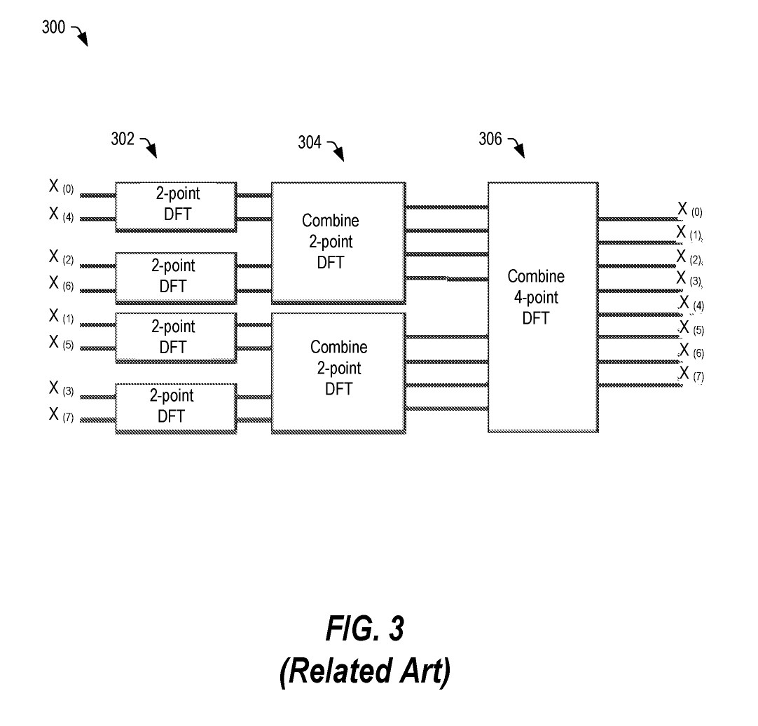

The decimation-in-time (DIT) FFT first rearranges the input elements into bit-reverse order, then builds up the output transform in logₑ N iterations. The DIT FFT computes an 8-point DIT DFT in three stages as depicted in FIG. 3.

FIG. 3 depicts a system 300 including three-stages in a computation of an N=8-point decimation-in-time (DIT) discrete Fourier transform (FFT). The system 300 may include a first stage 302 including four two-point DFT elements. Each DFT element can receive two inputs and can produce a two-point output, which outputs are provided to a second stage 304. The second stage 304 includes two elements, each of which combines two 2-point DFT outputs to produce a four-point DFT output. The system 300 further includes a third stage 306, which combines the four-point DFT outputs from each of the two processing elements of the second stage 304 to produce an 8-point DIT DFT output.

In the embodiments of FIG. 3, the eight-points DFT can be obtained at an output of the third stage 306 from two four-points DFTs at the output of the second stage 304. The two four-points DFTs can be obtained from the four two-points DFTs at the output of the first stage 302.

In general, higher radix butterfly implementations can reduce the communication burden. For example, a sixteen-point DFT can be determined in two stages of radix-4 butterflies, as shown in FIG. 2. The higher radix FFT algorithms can reduce a net number of mathematical operations (complex and trivial) and thus simplify the hardware implementation and reduce the memory access rate requirements. The number of stages corresponds to the amount of global communication and memory accesses in a given implementation. Thus, reducing the number of stages reduces the communication burden.

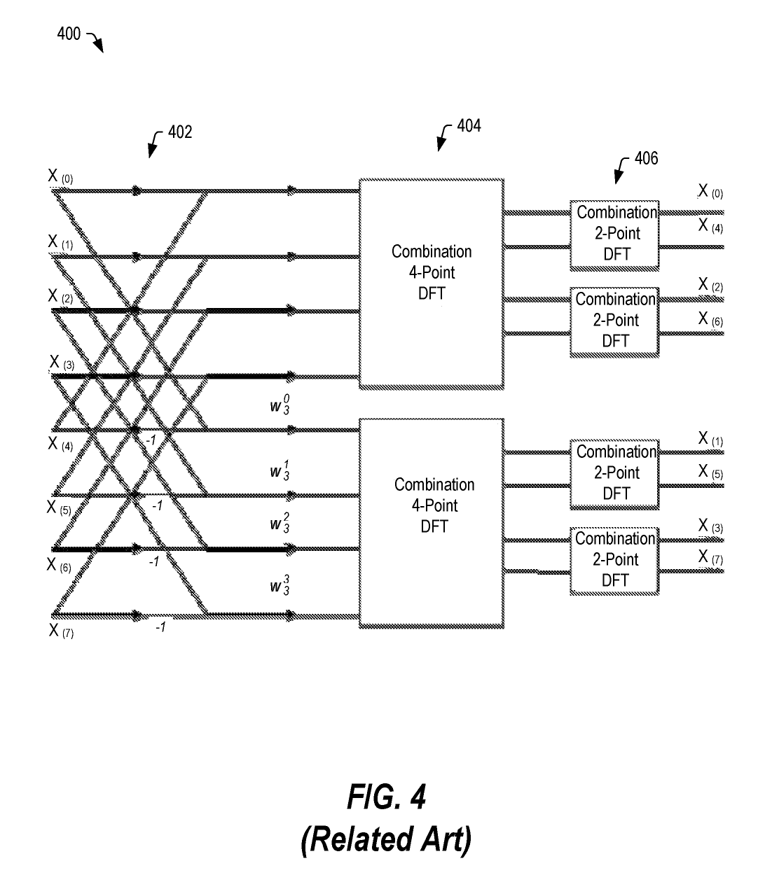

It is also possible to derive FFT algorithms that first go through a set of log₂ N iterations on the input data, and rearrange the output values into bit-reverse order. These are called decimation-in-frequency (DIF) DFT outputs. One possible example of a three-stage eight-point DIF FFT process is described below with respect to FIG. 4.

FIG. 4 depicts a system 400 including three-stages in an eight-point DIF FFT. In the following discussion, the three-stages include a first eight-to-four decimation stage 402, a second combination 4-Point DFT 404, and a combination 2-Point DFT 406. In the following discussion, the radix-2 DIF FFT is described as a pre-cursor to explaining the generalized radix-r DFT of the present disclosure.

The integers n and k in equation (1) (for the case N=2^{γ}) can be expressed in binary numbers depicted in the following equations:

n=2^{γ-1}n_{γ-1}+2^{γ-2}n_{γ-2}+ . . . +n₀, (2)

and

k=2^{γ-1}k_{γ-1}+2^{γ-2}k_{γ-2}+ . . . +k₀, (3)

in which the variables n and k can take the values 0 and one only. Accordingly, equation (1) can be rewritten as follows:

$${X}_{( {k}_{γ - 1} , {k}_{γ - 2} , … , {k}_{0} )} = {\sum }_{{n}_{0} = 0}^{1} … {\sum }_{{n}_{γ - 1} = 0}^{1} {x}_{( {n}_{γ - 1} , {n}_{γ - 2} , … , {n}_{0} )} {w}_{8}^{( {2}^{γ - 1} {n}_{γ - 1} + {2}^{γ - 2} {n}_{γ - 2} + … + {n}_{0} ) \times ( {2}^{γ - 1} {k}_{γ - 1} + {2}^{γ - 2} {k}_{γ - 2} + … + {k}_{0} )} . \qquad ( 4 )$$

Based on equation (4), the γ^{ple} sum can be divided into γ separate summations as follows:

$$\begin{matrix}{X}_{1 ( {k}_{0} , {n}_{γ - 2} , … , {n}_{0} )} = {\sum }_{{n}_{γ - 1} = 0}^{1} {x}_{( {n}_{2} , {n}_{γ - 1} , … , {n}_{0} )} \times {w}_{N}^{( {2}^{γ - 1} {n}_{γ - 1} + {2}^{γ - 2} {n}_{γ - 2} + … + {n}_{0} ) {k}_{0}} , & ( 5 ) \\ {X}_{2 ( {k}_{0} , {k}_{1} , {n}_{γ - 3} , … , {n}_{0} )} = {\sum }_{{n}_{γ - 2} = 0}^{1} {X}_{1 ( {k}_{0} , {n}_{γ - 2} , … , {n}_{0} )} \times {w}_{N}^{( {2}^{γ - 2} {n}_{γ - 2} + {2}^{γ - 3} {n}_{γ - 3} + … + {n}_{0} ) 2 {k}_{1}} , and & ( 6 ) \\ {X}_{γ ( {k}_{0} , {k}_{1} , … , {k}_{γ - 2} , {n}_{0} )} = {\sum }_{{n}_{γ - 2} = 0}^{1} {X}_{γ - 1 ( ( {k}_{0} , {k}_{1} , … , {k}_{γ - 2} , {n}_{0} ) )} {w}_{N}^{{n}_{0} {2}^{γ - 1} {k}_{γ - 1}} . & ( 7 )\end{matrix}$$

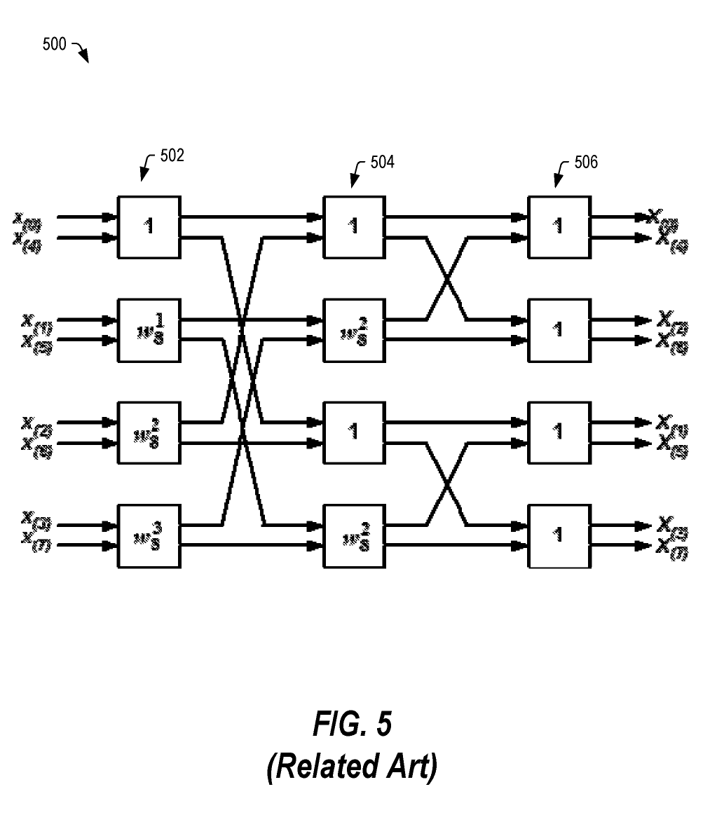

The computation of equation (1) can be divided into log₂N=γ stages, where each stage can have a computational complexity of N. As a result, the total computational complexity can be decreased from N² to N log₂ N. If the result needs to be in the natural order, an unscrambling stage for X_{γ} can be included. The signal flow graph for an 8-points radix-2 DIF FFT described below with respect to FIG. 5, in which the butterfly is introduced as a primitive operation of the FFT.

FIG. 5 depicts an eight-point DIF FFT signal flow graph 500, generally indicated at 500. In the DIF FFT signal flow graph 500, data can be fed to the input of the first stage 502 of butterfly-computing elements. After the first stage 502 of butterfly-computation is complete, the result may be provided as input to the second stage 504 of the butterfly computing elements. After the second stage 504 of the butterfly-computation is complete, the result may be provided as an input to the third stage 506, and so on.

In the illustrated example of FIG. 5, four radix-2 butterflies operate in parallel on eight input data points in each stage. The third stage 506 provides a complete 8-point DFT output.

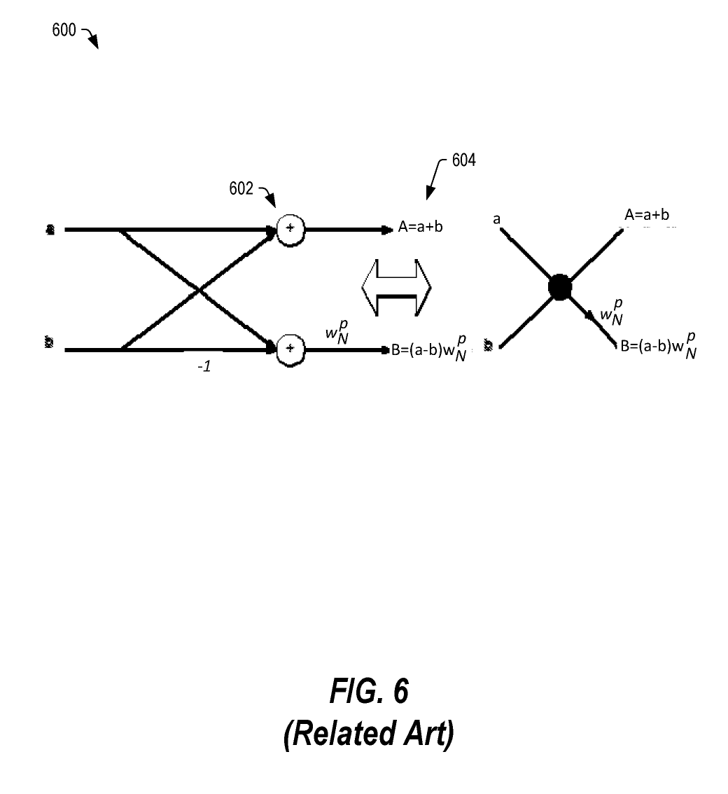

The radix-2 butterfly can include two complex additions and one complex multiplication. A conceptual representation of the radix-2 butterfly is described below with respect to FIG. 6.

FIG. 6 illustrates a butterfly computation 600 for the DIF FFT. In the illustrated example, the inputs a and b are provided as complex additions in a first stage 602. The computation 600 further includes a complex multiplication in a second stage 604.

The basis of the radix-r FFT is that a DFT can be divided into r smaller DFTs, each of which is divided into r smaller DFTs, in a continuing process that results in a combination of r point DFTs. By properly dividing the DFT into partial DFTs, the system can control the number of multiplications and stages. In some embodiments, the number of stages may correspond to the amount of global communication, the amount of memory accesses, or any combination thereof. Thus, advantages can be achieved by reducing the number of stages.

Conceptually, the FFT address generator can provide a simple mapping of the three indices (FFT stage, butterfly, and element) to the addresses of the multiplier coefficients. At the outset, equation (1) can be expressed in compact form as depicted in equation (8) below:

$$X = {T}_{r} {W}_{N} col ( {\sum }_{n = 0}^{\frac{N}{r} - 1} {x}_{( rn + q )} {w}_{N / r}^{np} \vert q = 0 , 1 , … , r - 1 ) , \qquad ( 8 )$$

for k=0, 1, L, N−1, and with p=0, 1, . . . , (N/r)−1 and q=0, 1, . . . , r−1, with

X=[X₍ₚ₎,X_{(p+N/r)},X_{(p+2N/r)}, . . . ,X_{(p+(r-1)N/r)}]^{T}, (9)

W_{N}=diag(w_{N}⁰,w_{N}^{p},w_{N}^{2p}, . . . ,w_{N}^{(r-1)p}), (10)

$${T}_{r} = [ \begin{matrix}{w}_{N}^{0} & {w}_{N}^{0} & {w}_{N}^{0} & … & … & {w}_{N}^{0} \\ {w}_{N}^{0} & {w}_{N}^{N / r} & {w}_{N}^{2 N / r} & … & … & {w}_{N}^{( r - 1 ) N / r} \\ {w}_{N}^{0} & {w}_{N}^{2 N / r} & {w}_{N}^{4 N / r} & ⋮ & ⋮ & {w}_{N}^{2 ( r - 1 ) N / r} \\ ⋮ & ⋮ & ⋮ & ⋮ & ⋮ & ⋮ \\ ⋮ & ⋮ & ⋮ & ⋮ & ⋮ & ⋮ \\ {w}_{N}^{0} & {w}_{N}^{( r - 1 ) N / r} & {w}_{N}^{2 ( r - 1 ) N / r} & … & … & {w}_{N}^{{( r - 1 )}^{2} N / r}\end{matrix} ] . \qquad ( 11 )$$

Therefore, by defining [Tᵣ]_{l,m} as the element at the l^{th} line and m^{th} column in the matrix Tᵣ equation (11) can be rewritten as follows:

[Tᵣ]_{l,m}= [symbol] (12)

where l=0, 1, . . . , r−1, m=0, 1, . . . , r−1 and [symbol] x [symbol] _{N} represents the operation x modulo N and where W_{N(m,v,s)} represents the set of the twiddle factor matrix as follows:

[W_{N}]_{l,m(v,s)}=diag( [symbol] _{N (0,v,s)}, [symbol] _{N (1,v,s)}, . . . , [symbol] _{N (r-1,v,s)}), (13)

where the indices r represents the FFT's radix; the values v=0, 1, . . . , V−1 represents the number of words of size r (V=N/r) and the value s=0, 1, . . . , S represents the number of stages (or iterations S=logᵣ N−1). Further, equation (13) can be expressed for the different stages in an FFT process as follows:

$${[ {W}_{N} ]}_{l , m ( v , s )} = \{ \begin{matrix}{w}_{N}^{{〚 ⌊ v / {r}^{s} ⌋ {lr}^{s} 〛}_{N}} & for l = m \\ 0 & elsewhere\end{matrix} , \qquad ( 14 )$$

for the DIF process. Equation (14) can be expressed as follows:

$${[ {W}_{N} ]}_{l , m ( v , s )} = \{ \begin{matrix}{w}_{N}^{{〚 ⌊ v / {r}^{( S - s )} ⌋ {lr}^{( S - s )} 〛}_{N}} & for l = m \\ 0 & elsewhere\end{matrix} , \qquad ( 15 )$$

for the DIT process, where l=0, 1, . . . , r−1 is the l^{th} butterfly's output, m=0, 1, . . . , r−1 is the m^{th} butterfly's input and └x┘ represents the integer part operator of x.

As a result, the l^{th} transform output during each stage can be illustrated according to the following equation:

$${X}_{( v , s )} [ l ] = {\sum }_{m = 0}^{r - 1} {x}_{( v , s )} [ m ] {w}_{N}^{{〚 lmN / r + ⌊ v / {r}^{s} ⌋ {lr}^{s} 〛}_{N}} , \qquad ( 16 )$$

for the DIF process and

$${X}_{( v , s )} [ l ] = {\sum }_{m = 0}^{r - 1} {x}_{( v , s )} [ m ] {w}_{N}^{{〚 lmN / r + ⌊ v / {r}^{( S - s )} ⌋ {mr}^{( S - s )} 〛}_{N}} , \qquad ( 17 )$$

for the DIT process.

The read address generator (RAG), the write address generator (WAG), and the coefficient address generator (CAG) can be used for DIF and DIT processes, respectively. The m^{th} butterfly's input data of the v^{th} word x₍ₘ₎ at the s^{th} stage (s^{th} iteration) is fed by equations (12) and (13) for the DIF process and by equation (14) for the DIF process of the RAG as follows:

$${RAG}_{( m , v , 0 )} = m \frac{N}{r} + v , \qquad ( 18 )$$

and for s>0

$${RAG}_{( m , v , s )} = m \frac{N}{{r}^{2}} + {〚 ⌊ \frac{v}{{r}^{( s - 1 )}} ⌋ \frac{N}{r} 〛}_{N} + {〚 k 〛}_{{r}^{( s - 1 )}} + ⌊ \frac{v}{{r}^{s}} ⌋ {r}^{( s - 1 )} \qquad ( 19 )$$

and for the DIT process

$${RAG}_{( m , v , s )} = m ( \frac{N}{{r}^{( s + 1 )}} ) + § {y}_{{r}^{( S - s )}}^{••} + ⌊ \frac{v}{{r}^{( S - s )}} ⌋ {r}^{( S + 1 - s )} , \qquad ( 20 )$$

where the butterfly's input m=0, 1, K, r−1, v=0, 1, K, V−1 and s=0, 1, K, S, S=logᵣ N−1.

For both cases, the l^{th} processed butterfly's output X_{(l,v,s)}(l=0, 1, K, r−1) for the v^{th} word at the s^{th} stage should be stored into the memory address location given for the WAG as follows:

WAG_{(l,v,s)}=l(N/r)+v, (21)

It should be noted that, for both algorithms, the input and output data are in natural order during each stage of the FFT process known at all stages as the Ordered Input Ordered Output (0100) algorithms. The coefficient multipliers (Twiddle Factors or Twiddle Coefficients), which are used during each stage and which are fed to the m^{th} butterfly's input of v^{th} word x₍ₘ₎ at the s^{th} stage (s^{th} iteration), are provided as follows:

$${CAG}_{( m , v , s )} = {〚 l ( mV + ⌊ \frac{v}{{r}^{s}} ⌋ {r}^{s} ) 〛}_{N} , \qquad ( 22 )$$

for the DIF process and

$${CAG}_{( m , v , s )} = {〚 m ( lV + ⌊ \frac{v}{{r}^{( S - s )}} ⌋ {r}^{( S - s )} ) 〛}_{N} , \qquad ( 23 )$$

for the DIT process. Based on equations (15), (20), (21), and (23), the generalized radix-r FFT can be implemented in a field-programmable gate array (FPGA), a circuit, or software that can execute on a processor. Regardless of how the mathematical processes are implemented, the generalized radix-r FFT can be used with a variety of different circuits, devices, and systems.

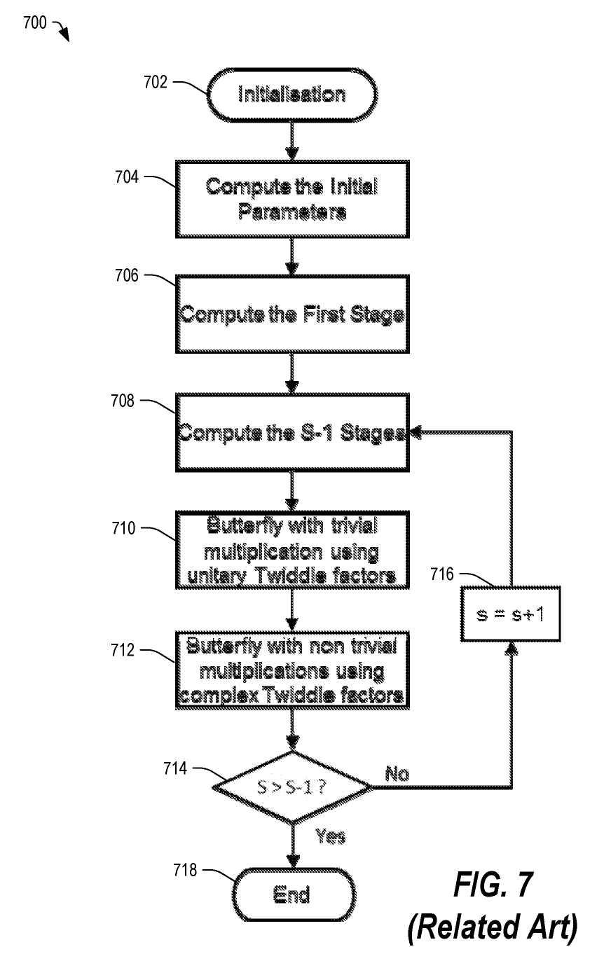

FIG. 7 depicts a general flow diagram of a DIT Radix-r address generator 700, in accordance with certain embodiments of the present disclosure. At 702, the method 700 can include initialization. At 704, the method 700 may include computing the initial parameters.

At 706, the method 700 can include computing the first stage. At 708, the method 700 may include computing the S−1 stages. At 710, the method 700 may include executing the butterfly computations with trivial multiplication using unitary Twiddle factors. At 712, the method 700 can include executing the butterfly computations with non-trivial multiplications using the complex Twiddle factors.

At 714, if the selected stage is not greater than the total number of stages minus one, the method 700 can include incrementing the stage counter at 716. The method 700 then returns to 708 to compute the S−1 stages. Returning to 714, if the selected stage is greater than the total number of stages minus one, the method 700 can terminate at 718.

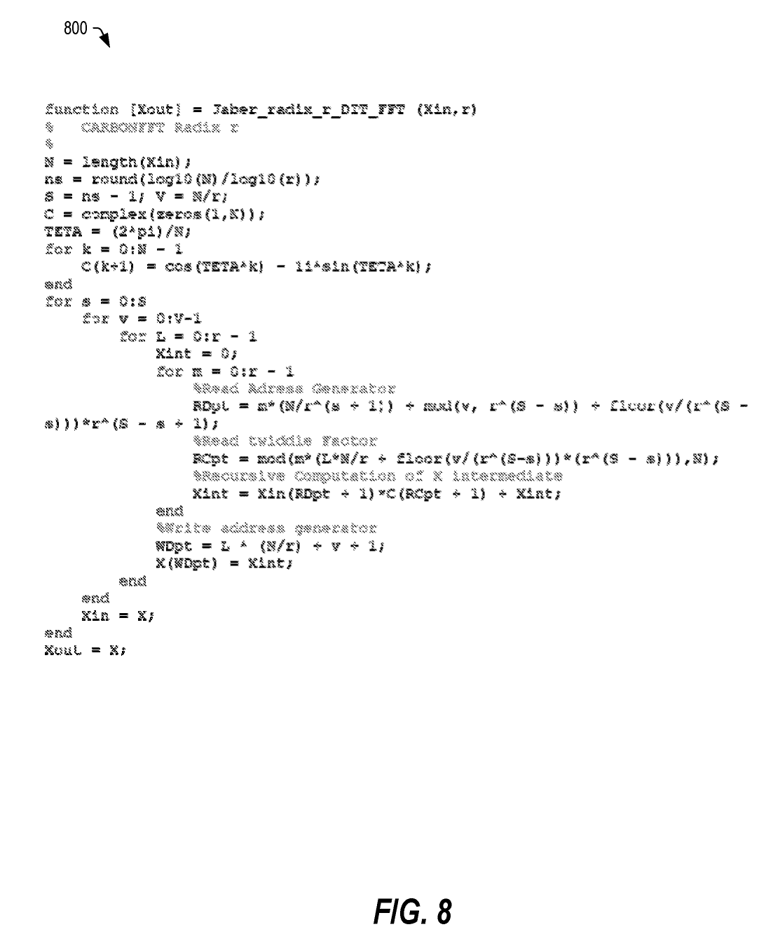

FIG. 8 depicts MATLAB® source code for a generalized radix-r DIT FFT, which source code is generally indicated at 800. Matlab® is a registered trademark (U.S. Trademark registration no. 1,691,313 for computer software for matrix calculation and instruction manuals therefor), which trademark registration is owned by MathWorks, Inc., having offices in Natick, Mass. The Matlab® software is publicly available for both professional and educational use. The source code 800 represents one possible implementation of a generalized radix-r FFT (where the radix r is configurable). The source code 800 provides an example of a process to compute the FFT for any positive integer DFT of length N, which can be of any integer length or even a prime number or multiple of a prime number. Further, the source code 800 may include nested loops, which are implemented as “for” loops that include a counter to increment or decrement with each iteration. Other embodiments are also possible.

In the source code 800, a plurality of “for” loops are nested to iteratively determine the read data addresses and the twiddle (coefficient) factor addresses and to determine the x-integer for the butterfly FFT. The illustrative source code 800 may correspond to equations 17, 20, and 23 above.

In some embodiments, the generalized radix-r FFT operations and the associated address generator and counters disclosed herein take advantage of the occurrence of the multiplication by one. For example, the elements of the twiddle factor matrix illustrated in equation (4) that may be equal to one can be easily predicted when the shifting counter in both cases is equal to zero (i.e., v<r^{s} or v<r^{(S-s)}). The trivial multiplication by one) (w⁰) during the entire FFT process is consequently avoided. Thus, embodiments of the present disclosure may take advantage of this mathematical equivalence to ensure that the zero-padding does not contribute to the computational load.

Additionally, as can be seen in the source code 800 of FIG. 8, one possible implementation of the generalized radix-r FFT can include an intensive modulo computation as well as the computation of the integer part operator of

$$⌊ \frac{v}{{r}^{( S - s )}} ⌋ .$$

However, the division (MOD) operation is more costly in terms of processor flops than multiplication and thus can be more intensive.

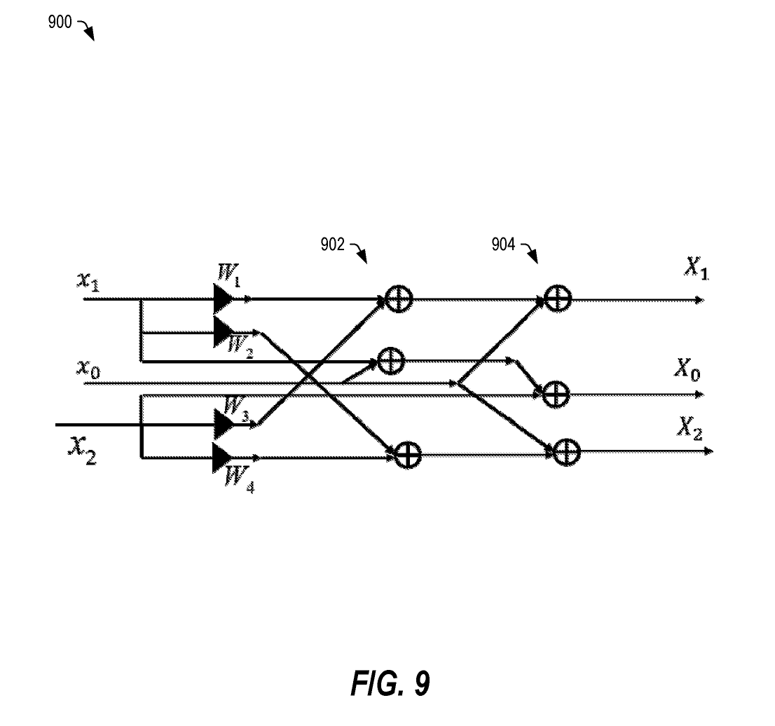

FIG. 9 depicts a block diagram of a logic circuit 900 configured to implement a modified radix-3 Butterfly operation, in accordance with certain embodiments of the present disclosure. The circuit 900 includes three inputs to receive input values (x₀, x₁, and x₂). The circuit 900 further includes three outputs to provide output values (X₀, X₁, and X₂). Between the inputs and the outputs, the circuit includes a first stage 902 and a second stage 904. The intermediate values (Wᵢ) for the twiddle factors of the DIT Radix-r address generator can be understood according to the following equations:

$${W}_{1} = {w}_{N}^{{〚 \frac{N}{3} + ⌊ v / {3}^{( S - s )} ⌋ {3}^{( S - s )} 〛}_{N}} , \\ {W}_{2} = {w}_{N}^{{〚 \frac{2 N}{3} + ⌊ v / {3}^{( S - s )} ⌋ 2 \times {3}^{( S - s )} 〛}_{N}} , \\ {W}_{3} = {w}_{N}^{{〚 \frac{2 N}{3} + ⌊ v / {3}^{( S - s )} ⌋ {3}^{( S - s )} 〛}_{N}} , and \\ {W}_{4} = {w}_{N}^{{〚 \frac{N}{3} + ⌊ v / {3}^{( S - s )} ⌋ 2 \times {3}^{( S - s )} 〛}_{N}} , \qquad ( 24 ) .$$

Many FFT users may prefer the natural order outputs of the computed FFT and that is why many developers have concentrated their efforts in reducing the computational time impact in the bit reversal stage, which is the first stage of the DIT process known as the bit reversal data shuffling technique. The DIT FFT has been attractive in fixed point implementations because DIT processes executed in fixed-point arithmetic have been shown to be more accurate than the decimation-in-frequency (DIF) processes. Furthermore, it is highly recommended to reorder the intermediate stage of the FFT algorithm in order to facilitate the operation on consecutive data elements for many hardware architectures. To these ends, a number of alternative implementations have been proposed. One such alternative implementation may adopt an out-of-place algorithm where the output array is distinct from the input array.

For example, in a bit-reversal technique developed by Rius and De Porata-Doria (J. M. Rius and R. De Porrata-Doria “New FFT Bit-Reversal Algorithm”, IEEE Transactions On Signal Processing, Vol. 43, No. 4, April 1995, pp. 991-994), the operational count excluding the index calculations for each stage as follows:

N−2 integer additions,

2(N−2)integer increments,

(log₂ N)−1 multiplications by 2,

(log₂ N)−1 divisions by 2, (25)

plus two more divisions N/2 and N/4. In equation (25), multiplications and divisions can be efficiently implemented using bit-shift operations. Further, this Rius implementation uses a storage table of N/2 index numbers. In contrast, a faster bit-reversal permutation is described by Prado (J. Prado “A New Fast Bit-Reversal Permutation Algorithm Based on Symmetry”, IEEE Signal Processing Letters, Vol. 11, No. 12, December 2004, pp. 933-936). An even faster implementation was described by Pei and Chang (S. Pei, K. Chang “Efficient Bit and Digital Reversal Algorithm Using Vector Calculation” IEEE Transactions on Signal Processing, Vol. 55, No. 3, March 2007, pp. 1173-1175). The embodiment described by Pei and Chang provides a significant improvement in the operation count, which includes N shifts, N additions, and an index adjusting and will require the use of O(N) memories.

However, embodiments of the radix-r implementation described herein do not utilize memory to store a table index number. Thus, the overall memory accesses can be reduced as compared to the prior implementation. A table is shown in Table 1 below; which depicts the memory storage for the three implementations described above.

TABLE 1
Memory for table index number

| Methods | Memory |
|---|---|
| Rius and De Porrata-Doria | N/2 |
| Prado | S even, \sqrt{N} |
| | S odd, \sqrt{N/2} |
| Pei [3] | N |
| FFT Algorithm herein | 0 |

By examining equations (16) and (17), it can be determined that the data in both algorithms were grouped with their corresponding coefficient multipliers at each stage because the m^{th} coefficient multiplier of the l^{th} butterfly's output shifts if, and only if, the v (v=0, 1, K, V−1) is equal to r^{(S-s)} in the DIF process or v=r^{s} in the DIT process. As a result, and since V=N/r=r^{S}; the total number of shifts during each stage in the DIT process would be r^{s} and the total number of shifts during each stage in the DIF process is r^{(S-s)}. Therefore, by implementing the word counter r^{(S-s)} (word-counter=0, 1, . . . , r^{(S-s)}−1) and the shifting counter r^{s} (shift-counter=0, 1, . . . , r^{s}−1) in the DIT process or the word counter r^{s} and the shifting counter r^{(S-s)} in the DIF process, embodiments of systems, methods and devices can achieve highly efficient, self-sorting DIT/DIF radix-r processes through which accesses to the coefficient multiplier's memory are reduced as compared with the conventional radix-r DIT/DIF processes.

The DIF FFT can be derived based on the above-equations and the discussion below. For the first iteration (i.e., s=0), equation (20) may equal equation (21) due to the fact that the second term of this equation may be equal to v and the third term may be equal to zero. Thus, for the first iteration, the RAG and WAG may have the same structure.

In fact, when s=0, the third term of equation (20) can be determined as follows:

$$⌊ \frac{v}{{r}^{( S - s )}} ⌋ {r}^{( S + 1 - s )} = ⌊ \frac{v}{{r}^{S}} ⌋ {r}^{( S + 1 )} , \qquad ( 26 )$$

and since r^{S}=V, equation (26) can be determined as follows:

$$⌊ \frac{v}{{r}^{S}} ⌋ {r}^{( S + 1 )} = ⌊ \frac{v}{V} ⌋ {r}^{( S + 1 )} . \qquad ( 27 )$$

Since v=0, 1, K, V−1 therefore,

$$⌊ \frac{v}{V} ⌋$$

is always equal to zero. Similarly, the second term [symbol] v [symbol] ᵣ_{^{(S−s)}} could be written as:

§v^{••}ᵣ_{^{(S−s)}}=§v^{••}ᵣ_{^{S}}=§v^{••}_{V}=v. (28)

Also, for the first iteration when s=0, the Coefficients Address Generator (CAG) illustrated in equation (23) could be expressed for a conventional radix-r butterfly where the term [symbol] mlV [symbol] _{N} represents the adder tree matrix Tᵣ, as follows:

$${CAG}_{( m , v , s )} = {〚 m ⌊ \frac{v}{{r}^{( S - s )}} ⌋ 〛}_{N} = {〚 m ⌊ \frac{v}{{r}^{S}} ⌋ {r}^{S} 〛}_{N} = {〚 m ⌊ \frac{v}{V} ⌋ {r}^{S} 〛}_{N} = 0. \qquad ( 29 )$$

As a result, the first iteration involves no twiddle factor multiplication.

For s>1, modulo and integer part operations dominate the workload in the reading and coefficient address generators. The variable [symbol] A [symbol] _{B} denotes A modulo B, which is equal to the residue (remainder) of the division of A by B, and the variable └A/B┘ denotes the quotient (Integer Part) of the division of A by B. The arithmetical operation modulo, in a hardware implementation, can be represented by a resettable counter. During each stage, v words (v=0, 1,K, V−1) may be processed. Thus, the third term of equations (20) and (23) is a function of r^{s} and could be replaced by the arithmetical operation modulo. In fact, since v varies between 0 and (V−1), the third term can be expressed as follows:

$$⌊ \frac{v}{{r}^{( S - s )}} ⌋ {r}^{( S + 1 - s )} = I ( {r}^{s} ) , \qquad ( 30 )$$

and will vary between 0 and r^{s}−1. As a result, the integer part operation in equations (20) and (23) can be simplified as follows:

$$⌊ \frac{v}{{r}^{( S - s )}} ⌋ § {I}_{{r}^{s}}^{••} , \qquad ( 31 )$$

for I=0, 1, . . . , r^{s}−1, s=0, 1, . . . , S, and S=logᵣN−1, where S is the number of stages.

Based on equations (31) and (33), for s>1, r^{(S-s)} words may encounter trivial multiplication (i.e., [symbol] ⁰=1). As a result, the proposed simplified algorithm can be based on three simple counters as follows:

1. Stage or Iteration Counter

s=0,1, . . . ,S

S=logᵣN−1; (32)

### 2. Shifting Counter

I=0,1, . . . ,r^{S}−1; (33)

and

3. Word Counter

M=0,1, . . . ,r^{(S-s)}−1. (34)

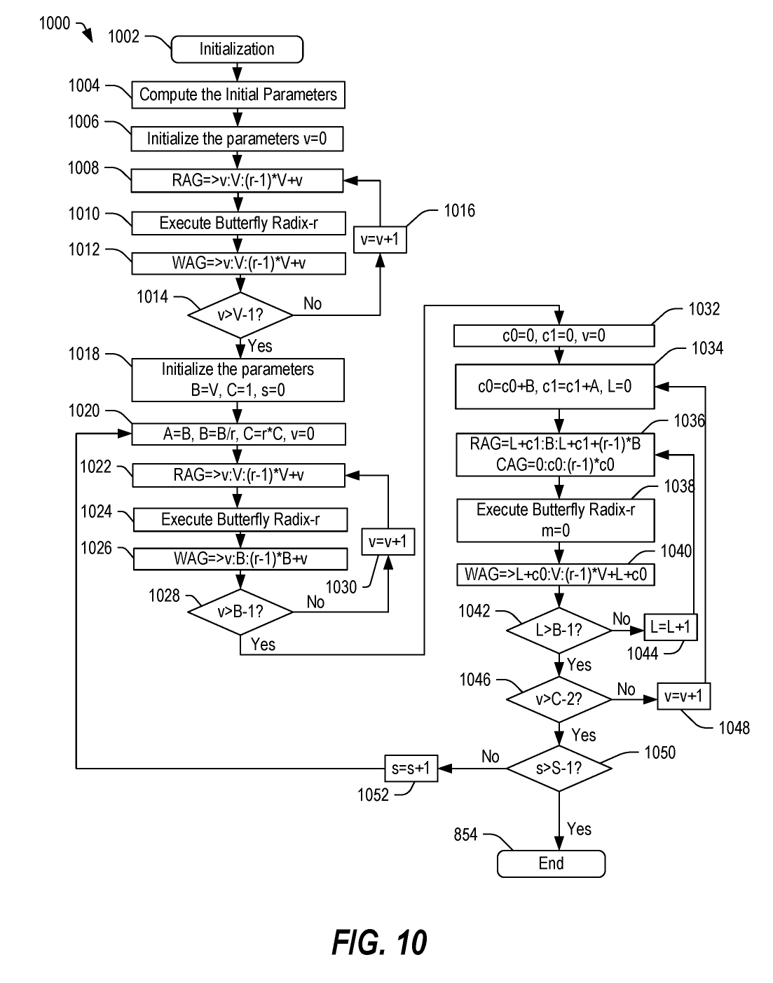

One possible implementation of the DIT radix-r address generator, which uses some of the above equations, is described below with respect to FIG. 10.

FIG. 10 depicts a flow diagram radix-r butterfly 1000, in accordance with certain embodiments of the present disclosure. At 1002, the method 1000 can include performing an initialization process. At 1004, the method 1000 may include computing the initial parameters. At 1006, the method 1000 may include initializing the parameters, including setting a word counter (v) equal to zero.

At 1008, the method 1000 can include determining a read address generator for each word. The method 1000 can also include executing the butterfly Radix-r, at 1010. At 1012, the method 1000 may include determining a write address generator for each word. At 1014, if the current word counter (v) is not greater than the total number of words minus one, the method 1000 may include incrementing the word counter, at 1016. The method 1000 may then return to 1008 to determine the read address generator.

Otherwise, at 1014, if the word counter is greater than the total number of words minus one, the method 1000 may include initializing a plurality of parameters, at 1018. At 1020, the method 1000 can include initializing a plurality of additional parameters. At 1022, the method 1000 may include determining the read address generator. At 1024, the method 1000 can include executing the butterfly Radix-r. At 1026, the method 1000 may include determining the write address generator. At 1028, if the word counter (v) is not greater than the total number of words (B) minus one, the method 1000 may include incrementing the word counter, at 1030. The method may then return to 1022 to determine the read address generator.

Otherwise, at 1028, if the word counter (v) is greater than the total number of words minus one, the method 1000 may include initializing a plurality of parameters, at 1032. At 1034, the method 1000 may include initializing further parameters. At 1036, the method 1000 can include determining a read address generator. At 1038, the method 1000 may include executing the Radix-r butterfly. At 1040, the method 1000 can include determining the write address generator.

At 1042, if the iteration counter (L) is not greater than a total number of words (B) minus one, the method 1000 may include incrementing the iteration counter 1044. The method 1000 may return to 1036 to determine the read address generator.

Returning to 1042, if the iteration counter (L) is greater than the total number of words (B) minus one, the method 1000 may advance to 1046. If, at 1046, the word counter (v) is not greater than a total number of words minus two, the method 1000 may include incrementing the word counter at 1048. The method 1000 may then advance to 1034 to initialize a plurality of parameters.

Returning to 1046, if the word counter (v) is greater than the total number of words minus two, the method 1000 can include advancing to 1050. If, at 1050, the stage counter (s) is not greater than the total number of stages minus one, the method 1000 may include incrementing the stage counter, at 1052. The method 1000 may then return to 1020 to initialize a plurality of parameters. Otherwise, at 1050, if the stage counter (s) is greater than the total number of stages minus one, the method 1000 may terminate, at 1054.

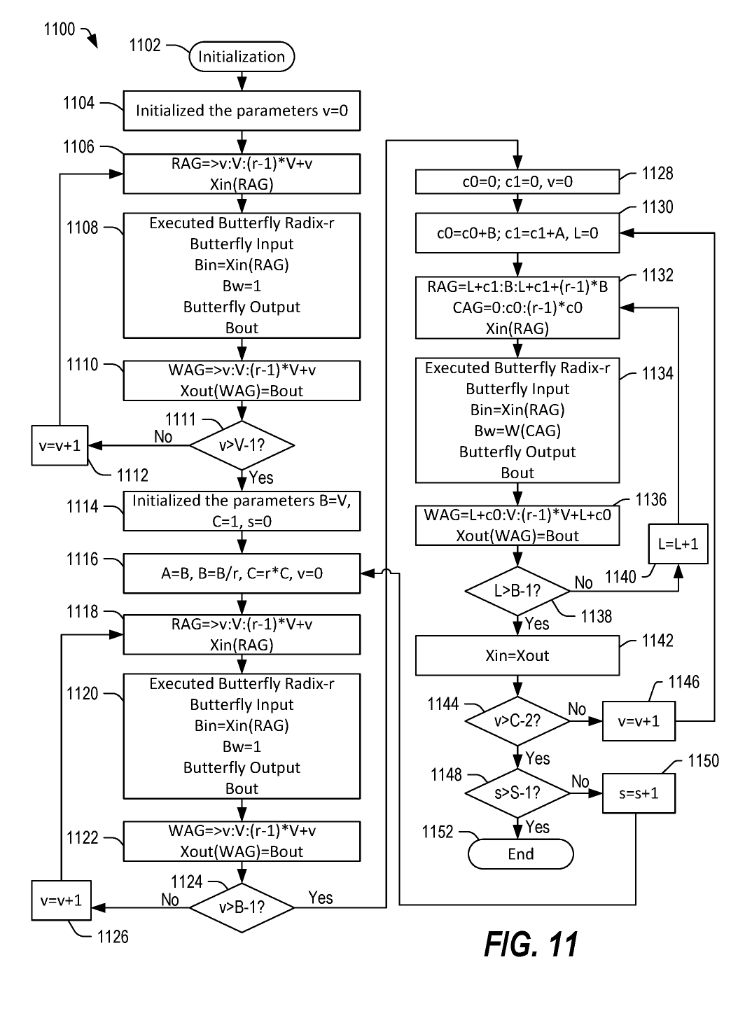

FIG. 11 depicts a flow diagram depicting a method 1100 of operating a radix-r address generator, in accordance with certain embodiments of the present disclosure. At 1102, the method 1100 may include initializing a plurality of parameters. At 1104, the method 1100 can include initializing the word counter parameter (v) equal to zero. At 1106, the method 1100 can include determining a read address generator. At 1108, the method 1100 can include executing the butterfly Radix-r. At 1110, the method 1100 may include determining the write address generator. At 1111, if the word counter (v) is not greater than the total number of words minus one, the method 1100 may include incrementing the word counter, at 1112. The method 1100 may then return to 1106 to determine the read address generator.

Returning to 1111, if the word counter (v) is greater than the total number of words minus one, the method 1100 may include initializing a plurality of parameters, at 1114. At 1116, the method 1100 may include initializing additional parameters. At 1118, the method 1100 may include determining the read address generator. At 1120, the method 1100 can include executing the butterfly Radix-r. At 1122, the method 1100 can include determining the write address generator. At 1124, if the word counter (v) is not greater than the total number of words minus one, the method 1100 may include incrementing the word counter at 1126. The method 1100 may then return to 1118 to determine the read address generator.

Returning to 1124, if the word counter (v) is greater than the total number of words minus one, the method 1100 may initialize a plurality of parameters at 1128 and 1130. The method 1100 may include determining a read address generator at 1132, executing the butterfly Radix-r at 1134, and determining a write address generator at 1136. At 1138, if the word counter (L) is not greater than the number of words minus one, the method 1100 may include incrementing the word counter at 1140 and then returning to 1130 to initialize some of the parameters.

Returning to 1138, if the word counter (L) is greater than the total number of words minus one, the method 1100 may include setting the input (Xin) equal to the output (Xout), at 1142. At 1144, if the shifting counter (v) is not greater than the total number of shifts minus two, the method 1100 may include incrementing the shifting counter at 1146 and returning to 1130 to initialize some of the parameters.

Returning to 1144, if the shifting counter (v) is greater than the total number of shifts minus two, the method 1100 may advance to 1148. At 1148, if the stage counter (s) is not greater than the total number of stages minus one, the method 1100 may increment the stage counter (s) at 1150. The method 1100 may then return to 1116 to initialize some of the parameters. Returning to 1148, if the stage counter (s) is greater than the total number of stages minus one, the method 1100 may terminate at 1152.

In general, the method 1000 in FIG. 10 and the method 1100 in FIG. 11 describe FFT algorithm with an FFT address generator that can compute the FFT of input data whose size is a multiple of an arbitrary integer a. For input data that is multiple of a, the complex memory requirements of the proposed algorithm is 2N, which product represents the input and sink memories. In certain embodiments, the radix-r FFT provided in FIG. 10 or in FIG. 11 utilizes three counters to access the data and the coefficient multipliers at each stage of the FFT. The use of the three counters can reduce the memory accesses to the coefficient multipliers, which reduction may be accomplished by regrouping the data with corresponding coefficient multipliers. Thus, the trivial multiplication by one (w⁰) during the entire FFT process can be avoided.

It should be appreciated that the method 1000 of FIG. 10 or the method 1100 of FIG. 11 may be implemented using a circuit, a microcontroller unit (MCU) or processor, a field programmable gate array, another data processing device, or any combination thereof. In the context of an instruction-based FFT device (such as an FFT implemented on a computing device that includes a processor that can execute instructions stored in a memory), a radix-r FFT instruction set may be executed by a processing circuit (such as a CPU Core) to provide an FFT computation. Possible software implementations of the DIT radix-r (2, 3 or 4) FFT are described below that can include an FFT address generator based, at least in part, on the methods.

In some embodiments, an apparatus, such as a processor, a central processing unit, or other data processing circuit, can be configured to implement the methods described with respect to at least one of FIGS. 10 and 11. The apparatus can include a memory configured to store data at a plurality of addresses. The apparatus can further include instructions that can be executed to implement a Radix-r fast Fourier transform (FFT) processor configured to determine a plurality of FFTs for any positive integer Discrete Fourier Transform (DFT) by utilizing three counters to access the data and the coefficient multipliers at each stage of the FFT processor. The three counters may be used for both read address generation and write address generation. In certain examples, the three counters and the methods discussed above enable a radix-r butterfly FFT process that includes fast and efficient memory accesses. More particularly, the resulting FFT may provide efficient calculation of discrete Fourier transforms of arbitrary sizes, including prime sizes.

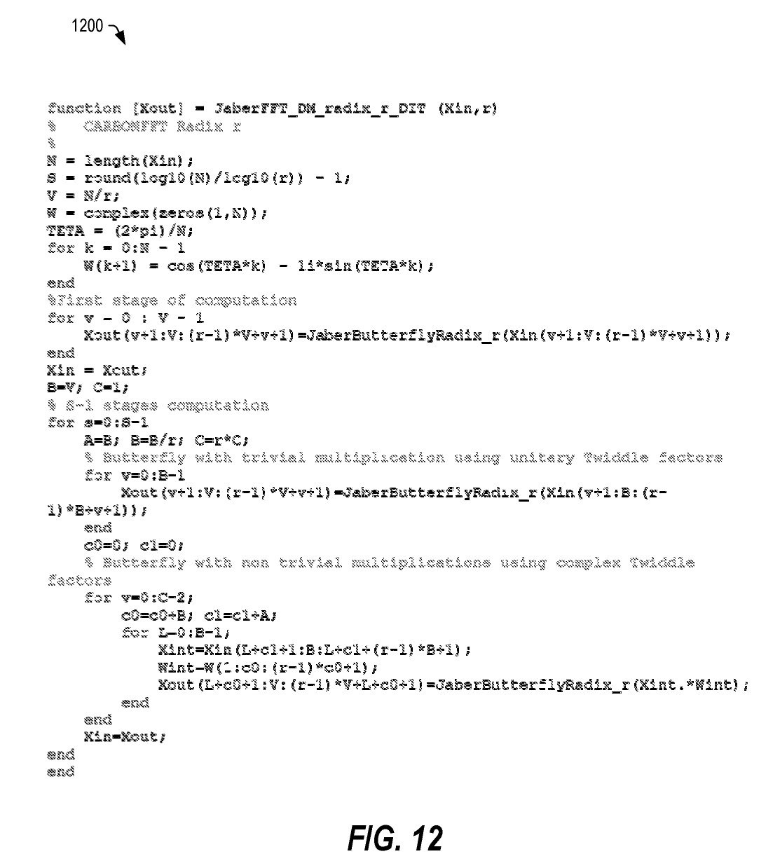

FIG. 12 depicts MATLAB® source code 1200 for the radix-r DIT FFT, in accordance with certain embodiments of the present disclosure. The source code 1200 may include a “for” loop for a first iteration where the stage (s) is equal to zero. Further, the source code 1200 includes a second, nested “for” loop configured to provide for trivial multiplication operations, and a third nested loop to determine the outputs (Xin=Xout).

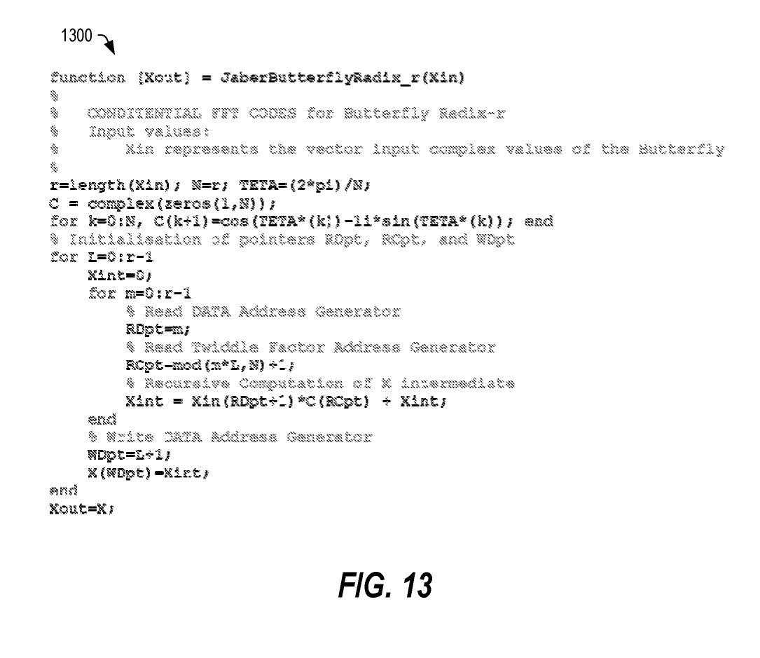

FIG. 13 depicts MATLAB® source code 1300 for the butterfly Radix-r represented by the function called by the MATLAB® source code 1200 of FIG. 12. The input values XBin represent the vector input complex values of the butterfly.

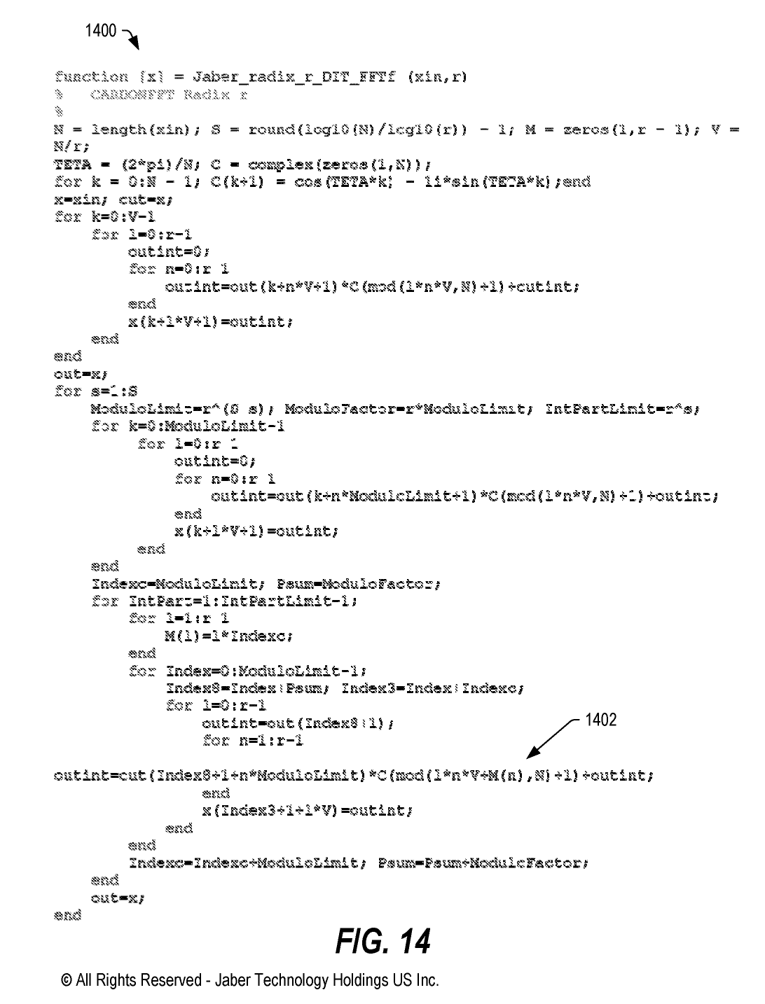

FIG. 14 depicts MATLAB® source code 1300 of a radix-r FFT with a butterfly adder tree matrix and the coefficient multipliers incorporated into a single stage of computation 1402, in accordance with certain embodiments of the present disclosure. The source code 1400 is similar to the source code 1200 of FIG. 12, except that the source code 1400 consolidates at least two lines of computations into one, reducing the computational overhead by at least one computation per iteration.

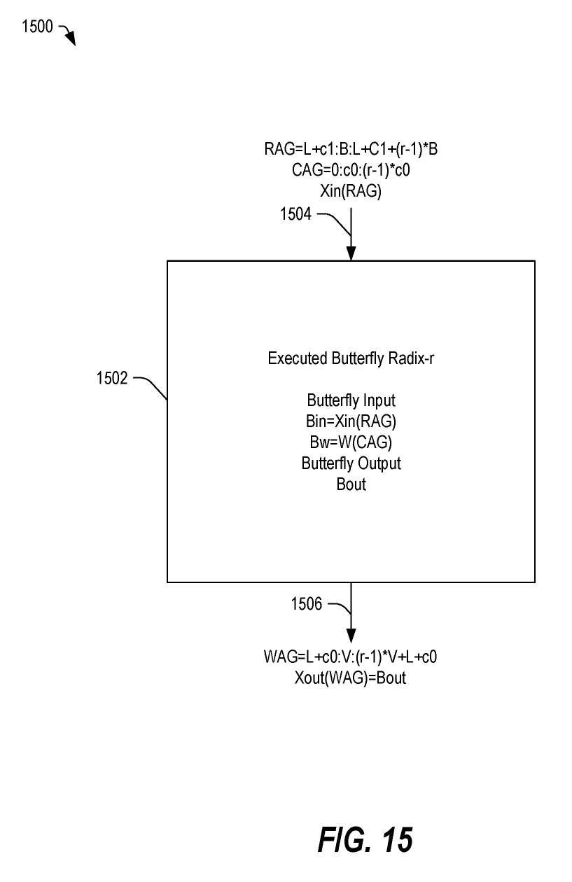

FIG. 15 depicts a block diagram 1500 of a radix-r DIT butterfly 1502, in accordance with certain embodiments of the present disclosure. The radix-r DIT butterfly 1502 may receive one or more inputs 1504 and may provide one or more outputs 1506. In the illustrated example, the one or more inputs 1504 may include a read address generator (RAG), a coefficient address generator (CAG), and an input function (Xin(RAG)). The one or more outputs 1506 may include a write address generator (WAG) and an output function (Xout(WAG)=Bout).

In the illustrated example, the butterfly input (Bin) includes the input function. The butterfly Radix-r 1502 may be configured to generate a butterfly output (Bout) as well as the butterfly write-address output (Bw).

While it should be appreciated that the examples above utilized Matlab® with the purpose of demonstrating the function, the generalized radix-R FFT functionality may be programmed utilizing other programming languages or utilizing software modules implemented in a variety of different programming languages and configured to share information. Examples provided are for illustrative purposes only and are not intended to be limiting.

In conjunction with the methods, devices, and systems described above with respect to FIGS. 1-15, a FFT algorithm with an FFT address generator is disclosed that uses counters to reduce the overall number of memory accesses. The FFT algorithm may be executed by one or more CPU cores and can be configured to operate with arbitrary sized inputs and with a selected radix. The FFT algorithm can be used to determine the FFT of input data, which input data has a size that is a multiple of an arbitrary integer a. The FFT algorithm may utilize three counters to access the data and the coefficient multipliers at each stage of the FFT processor, reducing memory accesses to the coefficient multipliers.

The processes, machines, and manufactures (and improvements thereof) described herein are particularly useful improvements for computers that process complex data. Further, the embodiments and examples herein provide improvements in the technology of image processing systems. In addition, embodiments and examples herein provide improvements to the functioning of a computer by enhancing the speed of the processor in handling complex mathematical computations by reducing the overall number of memory accesses (read and write operations) performed in order to complete the computations. Thus, the improvements provided by the FFT implementations described herein provide for technical advantages, such as providing a system in which real-time signal processing and off-line spectral analysis are performed more quickly than conventional devices, because the overall number of memory accesses (which can introduce delays) are reduced. Further, the radix-r FFT can be used in a variety of data processing systems to provide faster, more efficient data processing. Such systems may include speech, satellite and terrestrial communications; wired and wireless digital communications; multi-rate signal processing; target tracking and identifications; radar and sonar systems; machine monitoring; seismology; biomedicine; encryption; video processing; gaming; convolution neural networks; digital signal processing; image processing; speech recognition; computational analysis; autonomous cars; deep learning; and other applications. For example, the systems and processes described herein can be particularly useful to any systems in which it is desirable to process large amounts of data in real time or near real time. Further, the improvements herein provide additional technical advantages, such as providing a system in which the number of memory accesses can be reduced. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments, blocks may be removed or combined without departing from the scope of the disclosure. Further, structural and functional elements within the diagram may be combined, in certain embodiments, without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. An apparatus comprising:
a memory configured to store data at a plurality of addresses; and
a generalized radix-r fast Fourier transform (FFT) processor configured to determine a plurality of FFTs for any positive integer Discrete Fourier Transform (DFT) by utilizing three counters to access the data and the coefficient multipliers at each stage of the FFT processor.

2. The apparatus of claim 1, wherein the positive integer DFT is a prime number.

3. The apparatus of claim 1, wherein the generalized radix-r fast FFT processor performs a Decimation in Frequency (DIF) operation.

4. The apparatus of claim 1, wherein the generalized radix-r fast FFT processor performs a Decimation in Time (DIT) operation.

5. The apparatus of claim 1, wherein the generalized radix-r fast FFT processor includes an address generator configured to reduce memory accesses to coefficient multipliers of the FFTs stored by the plurality of addresses of the memory by regrouping data with their corresponding coefficient multipliers.

6. The apparatus of claim 5, wherein the regrouping of the data with their corresponding coefficient multipliers avoids trivial multiplication by one operations during the FFT calculation.

7. The apparatus of claim 5, wherein the regrouping of the data with their corresponding coefficient multipliers ensures that zero-padding within the FFT calculation does not contribute to computational load.

8. An apparatus comprising:
an input configured to receive input data having a size that is a multiple of an arbitrary integer a;
a memory configured to store data at a plurality of addresses; and
a generalized radix-R fast Fourier transform (FFT) processor coupled to the input into the memory, the generalized radix-r FFT processor configured to determine an FFT of the input data using three counters to access data and coefficient multipliers at each stage of the FFT processor.

9. The apparatus of claim 8, wherein the generalized radix-R FFT processor is configured to apply an interlaced decomposition to the input data to separate even and odd samples.

10. The apparatus of claim 8, wherein the generalized radix-R FFT processor is configured to determine an 8-point decimation in time discrete Fourier transform in three stages.

11. The apparatus of claim 8, wherein the generalized radix-R FFT processor is configured to determine an 8-point decimation in frequency discrete Fourier transform in three stages.

12. The apparatus of claim 8, wherein the generalized radix-R FFT processor is configured to iteratively divide a discrete Fourier transform (DFT) into a predetermined number of smaller DFTs

13. The apparatus of claim 12, wherein an address generator of the generalized radix-R FFT processor is configured to provide a simple mapping of an FFT stage, a butterfly stage, and an element to addresses of the coefficient multipliers.

14. The apparatus of claim 8, wherein the address generator is configured to reduce memory accesses to the coefficient multipliers of the FFTs stored by the plurality of addresses of the memory by regrouping data with their corresponding coefficient multipliers.

15. The apparatus of claim 14, wherein the regrouping of the data with their corresponding coefficient multipliers avoids trivial multiplication by one operations during the FFT calculation.

16. The apparatus of claim 14, wherein the regrouping of the data with their corresponding coefficient multipliers ensures that zero-padding within the FFT calculation does not contribute to computational load.

17. An apparatus comprising:
a memory configured to store data at a plurality of addresses; and
a generalized radix-r fast Fourier transform (FFT) processor configured to determine a plurality of FFTs for any positive integer Discrete Fourier Transform (DFT) by utilizing three counters to access the data and the coefficient multipliers at each stage of a plurality of stages of the FFT processor, the plurality of stages including an FFT stage and at least one butterfly stage.

18. The apparatus of claim 17, wherein the generalized radix-R FFT processor is configured to apply an interlaced decomposition to the input data to separate even and odd samples.

19. The apparatus of claim 17, wherein the generalized radix-R FFT processor is configured to determine an 8-point decimation in time discrete Fourier transform in three stages.

20. The apparatus of claim 17, wherein the generalized radix-R FFT processor is configured to determine an 8-point decimation in frequency discrete Fourier transform in three stages.
